(19) United States
(12) Patent Application Publication
(10) Pub. No.: US 2020/0338512 A1
(43) Pub. Date: Oct. 29, 2020

(54) OXYGEN REDUCTION SYSTEM WITH A UNIVERSALLY COMPATIBLE FRONT-END FOR COUPLING WITH VARIOUS DIFFERENT GAS SOURCES

(71) Applicants: Hans Peter Mueller, Denver, CO (US); Erik Myhren Anduri, Denver, CO (US); Ian Matthew Johantges, Denver, CO (US)

(72) Inventors: Hans Peter Mueller, Denver, CO (US); Erik Myhren Anduri, Denver, CO (US); Ian Matthew Johantges, Denver, CO (US)

(21) Appl. No.: 16/857,168

(22) Filed: Apr. 23, 2020

Related U.S. Application Data
(60) Provisional application No. 62/837,726, filed on Apr. 23, 2019.

(51) Int. Cl. B01J 8/00; B01J 8/02; B01J 8/04; B01D 53/86; C10G 5/06

(52) U.S. Cl. CPC B01J 8/001; B01J 8/0278; B01J 8/0285; B01J 8/0496; B01D 53/8671; C10G 5/06; B01D 2257/104; B01J 2208/00061; B01J 2208/00548; B01J 2219/00198; B01J 2219/00202; B01J 2219/0024; B01J 8/025

(57) ABSTRACT

Disclosed herein are various examples of systems, methods and devices for an oxygen reduction system with a universally compatible, adaptive front end that can be coupled with various different gas sources, wherein the oxygen reduction system determines its operations separate and independent from any signal lines from any upstream components or systems. In one example, the oxygen reduction system determines its functions, operations, and operational states from parameters that it measures from the input gas stream and other internal measurements. In this manner, installation of an oxygen reduction system is simplified, time-efficient and universal, and embodiments of the present disclosure provide for oxygen reduction systems that can be installed in a variety of different environments, applications, and with new or existing natural gas productions sites.

### CROSS-REFERENCE TO RELATED APPLICATIONS

This application claims priority to, and the benefit under 35 U.S.C. 119(e) of, U.S. Provisional Patent Application No. 62/837,726 filed Apr. 23, 2019 entitled “Oxygen Reduction System With A Universally Compatible Front-End For Coupling With Various Different Gas Sources” the disclosure of which is hereby incorporated by reference in its entirety. This application is also a continuation-in-part of co-pending U.S. patent application Ser. No. 15/723,862 entitled “Hydrocarbon Vapor Recovery System with Oxygen Reduction” filed Oct. 3, 2017, the disclosure of which is hereby incorporated by reference in its entirety.

### TECHNICAL FIELD

The present disclosure relates generally to systems used with natural gas wells or oil storage tanks.

### BACKGROUND

The present inventors have recognized that in the production and processing of natural gas, various natural gas sources may benefit from reduction of their oxygen content levels.

For instance, vapor recovery units are used to recover natural gas and other fuel vapors from natural gas or oil production facilities, where these vapors would otherwise be burned off by flares or would be otherwise released into the environment. U.S. Pat. Nos. 9,334,109; 9,764,255; and 9,776,155 (owned by the assignee of the present application) describe various examples of vapor recovery units.

One advancement developed by the assignee of the present application includes the use of an independent oxygen reduction system that can be used downstream of a vapor recovery unit, for instance as described in commonly assigned U.S. Pat. No. 9,776,155. In the '155 Patent, the oxygen reduction system may use signals or data obtained from an upstream vapor recovery unit, compressor, or other upstream device.

However, the present inventors have recognized that it can be time-consuming to connect the wires and other connections between a vapor recovery unit and an oxygen reduction system. It is against this background that embodiments of the present disclosure have been developed by the present inventors.

### SUMMARY

According to one broad aspect of one embodiment of the present disclosure, disclosed herein are various examples of oxygen reduction systems that include a universally compatible, adaptive front end that can be coupled with various different gas sources (such as but not limited to: an output vapor/gas line of a vapor recovery unit (VRU); the output of a compressor; a natural gas line produced at a well site; or from an existing gas gathering line contaminated with oxygen) wherein the oxygen reduction system determines its operations separate and independent from any signal lines from any upstream components or systems. In one example, the oxygen reduction system determines its functions, operations, and operational states from parameters that it measures from the input gas stream and other internal measurements.

In this manner, an oxygen reduction system can be coupled with a variety of different gas sources (such as VRUs or other devices or systems made by any manufacture) without having to connect signal lines, sensor data or other control lines from any upstream components to the oxygen reduction system—thereby making installation of an oxygen reduction system less complicated, more time-efficient and universal. Also in this manner, embodiments of the present disclosure provide for oxygen reduction systems that can be installed in a variety of different environments, applications, and new or existing natural gas productions sites.

According to one broad aspect of an embodiment of the present disclosure, disclosed herein is an oxygen reduction system for reducing an amount of oxygen from a stream of natural gas. In one example, the system may include a controllable inlet valve receiving the stream of natural gas, the inlet valve having an output; a controllable heating element receiving the output of the inlet valve and heating the stream of natural gas, the heating element having an output providing heated gas; and a vessel containing an oxygen reducing catalyst, the vessel receiving the heated gas and reducing oxygen contained within the heated gas, the vessel having an output providing oxygen reduced gas. The system may also include at least one temperature sensor detecting the temperature of the heating element; at least one temperature sensor detecting the temperature of the catalyst vessel; and a controller receiving said detected temperature of the heating element and the temperature of the catalyst vessel, the controller having an output coupled with the inlet valve to control the inlet valve, the controller also having another output coupled with the heater to control the heater.

In one example, the controller regulates the flow of gas into the inlet valve based on the temperature of the heating element. The controller may also regulate the amount of power (i.e., voltage, current, electrical power) applied to the heating element.

In another example, the system may also include a controllable outlet valve receiving the oxygen reduced gas, the outlet valve having a control line coupled with the controller, the controller selectively diverting the oxygen reduced gas through the outlet valve to a sales line or to a flare.

In another example, the system may include a heat exchanger having a first input receiving the stream of natural gas from the output of the inlet valve and a second input receiving the output from the vessel, the heat exchanger providing a first output to an input of the heater and a second output to a gas gathering line.

The stream of natural gas may be provided from a compressor, a vapor recovery unit (VRU) or other source of gas. The heating element may be a resister. The vessel may be vertically orientated, and may contain a sulfur removing material.

In one example, the controller closes the inlet valve if the temperature of the heating element exceeds a setpoint. In another example, the controller closes the inlet valve if the controller does not detect the temperature of the heating element. The heating element may be positioned within the vessel.

In another example, the system may include an oxygen sensor detecting an amount of oxygen content in the oxygen reduced gas, wherein the controller is coupled with said oxygen sensor.

According to one broad aspect of an embodiment of the present disclosure, disclosed herein is an oxygen reduction system for reducing an amount of oxygen from a stream of natural gas. In one example, the system may include a controllable inlet valve receiving the stream of natural gas, the inlet valve having an output; a controllable heating element receiving the output of the inlet valve and heating the stream of natural gas, the heating element having an output providing heated gas; and a vessel containing an oxygen reducing catalyst, the vessel receiving the heated gas and reducing oxygen contained within the heated gas, the vessel having an output providing oxygen reduced gas; wherein the heating element is positioned within the vessel.

According to one broad aspect of an embodiment of the present disclosure, disclosed herein is an oxygen reduction system for reducing an amount of oxygen from a stream of natural gas. In one example, the system may include a controllable inlet valve receiving the stream of natural gas, the inlet valve having an output; a controllable heating element receiving the output of the inlet valve and heating the stream of natural gas, the heating element having an output providing heated gas; a vessel containing an oxygen reducing catalyst, the vessel receiving the heated gas and reducing oxygen contained within the heated gas, the vessel having an output providing oxygen reduced gas; at least one temperature sensor detecting the temperature of the heating element; at least one temperature sensor detecting the temperature of the catalyst vessel; and a controller receiving said detected the temperature of the heating element and the temperature of the catalyst vessel, the controller having an output coupled with the inlet valve to control the inlet valve, the controller also having another output coupled with the heater to control the heater. In one example, the controller regulates the flow of gas into the inlet valve based on the temperature of the heating element.

Other embodiments of the disclosure are described herein. The features, utilities and advantages of various embodiments of this disclosure will be apparent from the following more particular description of embodiments as illustrated in the accompanying drawings.

### BRIEF DESCRIPTION OF THE FIGURES

FIG. 1 illustrates an example of an oxygen reduction system receiving (at its input) gas from a gas source, and providing at its output, gas with a reduced oxygen content, wherein the oxygen reduction system has a universally compatible front-end, in accordance with various embodiments of the present disclosure.

FIG. 2 illustrates another example of an oxygen reduction system receiving (at its input) gas from a gas source (the output of a compressor), and providing at its output, gas with a reduced oxygen content, wherein the oxygen reduction system has a universally compatible front-end, in accordance with various embodiments of the present disclosure.

FIG. 3 illustrates an example of an oxygen reduction system receiving (at its input) gas from a gas source, and providing at its output, gas with a reduced oxygen content, wherein the oxygen reduction system has a universally compatible front-end, in accordance with various embodiments of the present disclosure.

FIG. 4 illustrates an example of controller of an oxygen reduction system with a universally compatible front-end, in accordance with various embodiments of the present disclosure.

FIG. 5 illustrates an example of process operations of an oxygen reduction system, in accordance with various embodiments of the present disclosure.

FIG. 6 illustrates an example of PID loop that may be implemented by a controller of an oxygen reduction system, in accordance with various embodiments of the present disclosure.

FIGS. 7A-C illustrate various examples of scenarios of parameters measured by a controller of an oxygen reduction system, in accordance with various embodiments of the present disclosure.

FIGS. 8-9 illustrate an example of a reactor/vessel with a heater contained within the vessel, in accordance with various embodiments of the present disclosure.

### DETAILED DESCRIPTION

Disclosed herein are various embodiments of systems, methods and devices for an oxygen reduction system with a front-end that is compatible with a variety of different gas sources—such as but not limited to: an output vapor/gas line of a vapor recovery unit (VRU), the output of a compressor, a natural gas line produced at a well site, from an existing gas gathering line contaminated with oxygen, or other site or application. In one example, the front end of the oxygen reduction system is universally-compatible with a variety of different systems, without additional signal lines or data signals being connected from any upstream components or systems to the oxygen reduction system, thereby simplifying the installation and operation of the oxygen reduction unit. Another benefit of some embodiments of the present disclosure is that an oxygen reduction system with a universal front-end can be coupled with, installed with, or used with VRUs or other devices or systems made by different manufacturers, or with existing oil wells or natural gas production well sites—in an efficient manner without having to connect signal lines or data signals from the upstream systems to the oxygen reduction system. In one example, the oxygen reduction system may operate in a stand-alone, independent manner, wherein the oxygen reduction system determines its operations separate and independent from any signal lines from any upstream components or systems. In one example, the oxygen reduction system determines its functions, operations, and operational states from parameters that it measures from the input gas stream and other internal measurements.

In this manner, an oxygen reduction system can be coupled with a variety of different gas sources (such as VRUs or other devices or systems made by any manufacture) without having to connect signal lines, sensor data or other control lines from any upstream components to the oxygen reduction system—thereby making installation of an oxygen reduction system less complicated, more time-efficient and universal. Also in this manner, embodiments of the present disclosure provide for oxygen reduction systems that can be installed in a variety of different environments, applications, and with new or existing natural gas productions sites. Various examples of embodiments of the present disclosure are described herein.

The following detailed description refers to the accompanying drawings that depict various details of examples selected to show how particular embodiments may be implemented. The discussion herein addresses various examples of the inventive subject matter at least partially in reference to these drawings and describes the depicted embodiments in sufficient detail to enable those skilled in the art to practice the embodiments. Many other embodiments may be utilized for practicing the subject matter other than the illustrative examples discussed herein, and many structural and operational changes in addition to the alternatives specifically discussed herein may be made without departing from the scope of the disclosed subject matter.

In this description, references to “one embodiment” or “an embodiment,” or to “one example” or “an example” mean that the feature being referred to is, or may be, included in at least one embodiment or example of the disclosure. Separate references to “an embodiment” or “one embodiment” or to “one example” or “an example” in this description are not intended to necessarily refer to the same embodiment or example; however, neither are such embodiments mutually exclusive, unless so stated or as will be readily apparent to those of ordinary skill in the art having the benefit of this disclosure. Thus, the present disclosure includes a variety of combinations and/or integrations of the embodiments and examples described herein, as well as further embodiments and examples as defined within the scope of all claims based on this disclosure, as well as all legal equivalents of such claims.

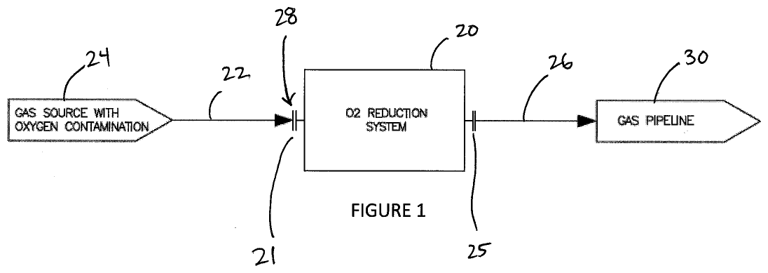

FIG. 1 illustrates an example of an oxygen reduction system 20 receiving (at its input or inlet 21) gas 22 from a gas source 24, and providing at its output 25, gas 26 with a reduced oxygen content, wherein the oxygen reduction system 20 has a universally compatible front-end 28, in accordance with various embodiments of the present disclosure.

In FIG. 1, a natural gas stream 22 from a gas source 24 is contaminated with oxygen, preventing it from being permitted to enter into a natural gas gathering pipeline 30. The natural gas stream 22 could be from a multitude of sources, such as but not limited to the output/discharge of a compressor or Vapor Recovery Unit (VRU), natural gas produced at a well site, from an existing gas gathering line contaminated with oxygen, from a natural gas well head, etc. In accordance with one embodiment of the present disclosure, a stand-alone oxygen reduction system 20 is provided and installed so that the oxygenated natural gas stream 22 is coupled with an inlet 21 of the oxygen reduction system 20. No external signals or other inputs are required for safe, effective, and reliable operation of the oxygen reduction system 20 (apart from electrical power as discussed herein).

The oxygen reduction system 20 eliminates or significantly reduces oxygen from the natural gas stream 22, and delivers oxygen-free natural gas 26 into the natural gas pipeline 30.

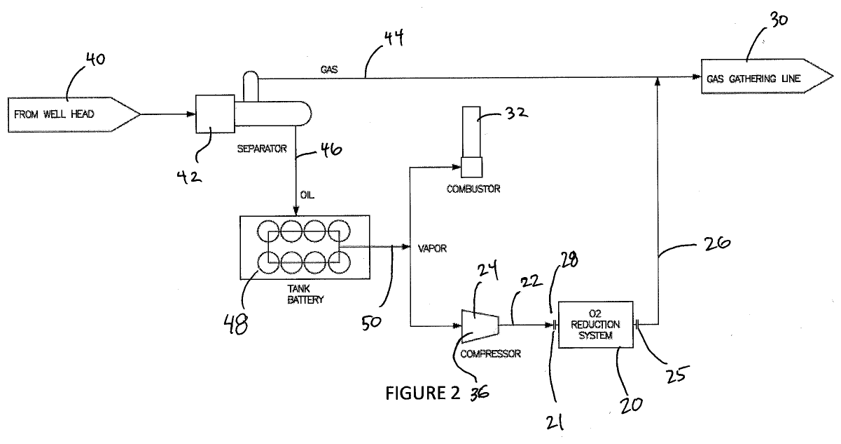

FIG. 2 illustrates another example of an oxygen reduction system 20 receiving (at its input or inlet 21) gas 22 from a gas source 24 (for instance, gas/vapor compressed by a compressor/VRU 36 with an output 38), and providing at its output 25, gas with a reduced oxygen content, wherein the oxygen reduction system 20 has a universally compatible front-end 28, in accordance with various embodiments of the present disclosure.

In FIG. 2, fluids produced from a wellhead 40 include natural gas, natural gas liquids, oil, and water. Natural gas, oil (hydrocarbons in liquid phase) are separated from one another in the separator 42. Gas 44 is sent directly to the gas gathering pipeline 30, and water is sent to dedicated water tanks (not shown). Oil 46 is sent into dedicated oil tanks 48, shown in FIG. 2 as a battery or set of oil tanks.

Some of the hydrocarbons in liquid phase “flash” into a gas phase (via a process that is similar to evaporation), creating flash gas/vapor 50 in the top space inside the oil tank battery 48. Air containing oxygen is almost always present at varying concentrations in the top/vapor space of the oil storage tanks 48 in the tank battery. The air enters the tanks 48 from a variety of points or ways.

In one example, the flash vapor 50 from the oil storage tanks 48 may be directed to a compressor i.e. a vapor recovery unit (VRU), for instance as described in U.S. Pat. No. 9,776,155 the disclosure of which is hereby incorporated by reference in its entirety.

In the example of FIG. 2, the oxygen reduction system 20 with a universal front end 28 is connected with the gas/vapor output 38 of the gas source 24 (which can be in one example a compressor or VRU 36). The oxygen reduction system 20 removes oxygen from the flash vapor stream 22 received from the compressor/VRU 36, which thereby allows the processed flash vapor 26 (having the oxygen removed therefrom) to enter into the gas gathering pipeline 30 (also referred to as the sales line).

As described herein, the oxygen reduction system 20 determines its operations and functions from its internal parameters, as well as characteristics that the oxygen reduction system 20 measures from the gas/vapor 22 that the oxygen reduction system 20 receives from the output 38 of the VRU or compressor 36. In one example, the oxygen reduction system 20 does not receive any signal lines or data lines from the VRU 36. This feature allows the oxygen reduction system 20 to be added to or connected with any existing VRU or compressor 36 in the field, or to a new VRU or compressor 36 made by any manufacturer, in an efficient manner.

In overall operation, the oxygen reduction system 20 receives recovered vapor/gas 22 from the VRU or compressor 36, and such recovered vapor/gas is typically compressed. As described herein, the oxygen reduction system 20 reduces an amount of oxygen present in the compressed recovered vapor/gas 22 to form oxygen reduced recovered vapor/gas 26, which can then be introduced into the sales line 30 of the system. The oxygen reduced recovered gas 26 produced by the oxygen reduction system 20 is within the specifications/parameters of sales gas, in terms of its oxygen content, temperature and pressure. By the combined use of a VRU or compressor 36 and oxygen reduction system 20 with a universally compatible front-end 28, a producer of natural gas can recover substantial amounts of natural gas that would otherwise be burnt off into the atmosphere thru flare or combustor 32.

In both FIGS. 1 and 2, in one example, a connection to the inlet 21 or front-end 28 of the oxygen reduction system 20 is a gas line, which can use conventional gas line mechanical coupling structures such as flanges. An output 25 of the oxygen reduction system 20 may also be a gas line, which can also use mechanical coupling structures such as flanges.

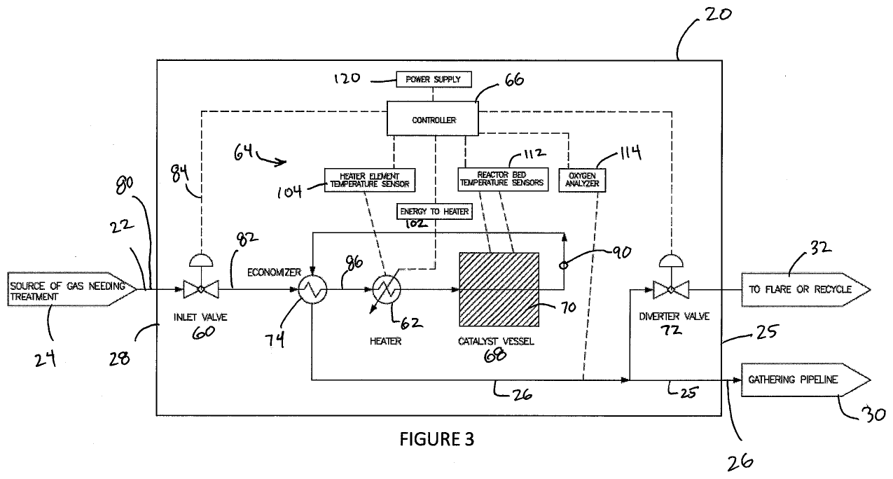

FIG. 3 illustrates a block diagram of an example of an oxygen reduction system 20 receiving (at its input) gas 22 from a gas source 24, and providing at its output 25, gas 26 with a reduced oxygen content, wherein the oxygen reduction system 20 has a universally compatible front-end 28, in accordance with various embodiments of the present disclosure. As shown as described herein, the oxygen reduction system 20 can universally apply to and connect with many different applications and systems without any inputs signals or other communication signals to/from third-party equipment.

In one example and as shown in FIG. 3, an oxygen reduction system 20 may include a controllable inlet valve 60, a heater 62, a set of sensors 64 (such as 104, 112, 114), a controller 66 (such as a programmable logic controller (PLC), microcontroller, microprocessor, computer or other electronic device), a catalyst vessel/reactor 68 containing an oxygen-reducing catalyst 70, and a controllable diverter valve 72. An economizing heat exchanger 74 may also be utilized in some embodiments. These components may be positioned upon and secured to a skid, base plate or other structure—so that the oxygen reduction system 20 is independent, stand-alone, universally compatible, self-contained, and portable. The oxygen reduction system 20 can be lifted by a crane from above, or lifted by a forklift, and transported to or from the desired location of its use by a flatbed truck or other vehicle.

The controllable inlet valve 60 is positioned on the front-end of the oxygen reduction system 20, and includes an inlet input/flange 80 which can be connected to receive a source 24 of gas 22—such as the gas sources 24 described herein. Such gas sources 24 typically contain oxygen levels which may be above a desired O2 content, where embodiments of the present disclosure can be used to reduce the oxygen content of the gas.

The controllable inlet valve 60 also includes an output line 82 which may direct gas 22 received from the inlet input 80 to the output line 82 when the valve 60 is open. The inlet valve 60 also includes a control line 84, which may be coupled to an output/control signal of the controller 66 to selectively open or close the inlet valve 60. In one example, the controller output signal is coupled through a solenoid and a relay to the control line 84 of the inlet valve 60.

As described herein, the controller 66 selectively determines the state of the inlet valve 60—open or closed. The inlet valve 60 can be fully closed in its de-energized state. During a power loss or should some event interrupt the signal to this inlet valve 60, it will close.

In one example, the controller 66 selectively opens the inlet valve 60 during all times when the oxygen reduction system 20 is on line, except i) if an Emergency Shutdown is activated which can be induced either by pressing a physical button on the controller 66 or via a remote signal delivered through automation; ii) if the oxygen reduction system 20 nears its maximum operating temperature. Oxygen reduction as achieved by the oxygen reduction system 20 is an exothermic process that produces heat, so that flash gas or other incoming oxygenated gas 22 with higher oxygen content would produce more heat. In one example, the oxygen reduction system 20 can be designed to process incoming oxygenated gas 22 containing oxygen levels up to 5% oxygen, before the oxygen reduction system 20 would reach its maximum operation temperature that would trigger closure of the inlet valve 60 to prevent overheating of the oxygen reduction system 20; iii) if a system malfunction is detected, i.e. loss of signal from a temperature sensor 104 or 112.

This functionality of the controller 66 to selectively open or close the inlet valve 60 allows the oxygen reduction system 20 to operate safely and to shut off flow of incoming oxygenated gas 22 by closing the inlet valve 60, without the need for signals to be sent to external equipment, i.e. a permissive signal for a compressor to run or stop, or for signals to be received by the oxygen reduction system 20 from devices or equipment that are external to the oxygen reduction system.

Eliminating flow of gas 22 into the oxygen reduction system 20 by closing the inlet valve 60 is also one way in which to effectively cool the catalyst bed 70 in the pressure vessel 68.

The output 82 of the inlet valve 60 may be coupled with an input of a heat exchanger 74, which can be configure to operate as an economizer. Another input of the economizer 74 can be coupled to receive the output of the vessel 68 to receive de-oxygenated gas 26. An output of the economizer 74 may be coupled with the input 86 of the heater 62. Another output of the economizer 74 can be routed to and provided as the output 25 of the oxygen reduction system 20. The economizing heat exchanger 74 may in one example be a plate exchanger, and such as a plate heat exchanger made by Alfa Laval (i.e., model Alfa Nova 76). In one example, the heat exchanger may be connected in a counterflow or crossflow configuration to maximize heat exchange and improve efficiency of the heat exchanger.

The economizer 74 removes heat from the de-oxygenated stream 90 from the output of the vessel 68 prior to exiting the oxygen reduction system 20, thereby effectively cooling the outlet stream 26 of the oxygen reduction system 20. This heat received by the economizer 74 (from either the heater or exothermic oxygen reduction process) is also combined/fed by the economizer 74 into the gas stream. The economizer/heat exchanger then puts the removed heat into the inlet stream at 86, effectively raising the temperature of the gas prior to it contacting the heater 62. This both reduces energy consumed by heater 62 during operations—and also cools the outlet gas 26 which enhances operator safety and allows the gas 26 to be sold as sales gas which typically should be at temperatures less than 120 degrees F.

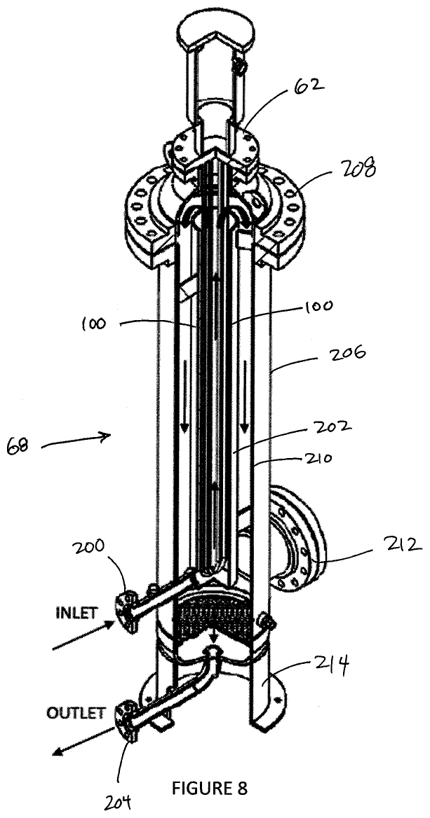

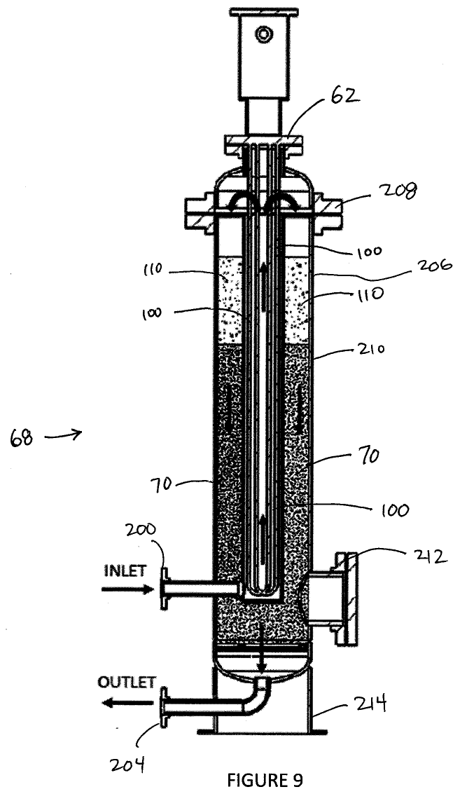

The heater 62 heats the incoming oxygenated gas 22 to an elevated temperature in order for the exothermic oxygen reduction process to occur within the pressure vessel/reactor 68 that contains an oxygen reducing catalyst 70. In one example and as shown in FIGS. 8-9, the heater 62 may be formed using elongated resistive heater elements 100 that generate heat when electrical current flows through the resistive elements 100. The resistive heater elements 100 can be positioned within the catalyst vessel/reactor 68, wherein the amount of heat generated by the heater 62 can be electronically controlled by controlling the power/wattage dissipated through the resistive heater elements 100, by controllably regulating the amount of voltage applied across the resistive heater elements 100 by the controller 66 (shown in FIG. 3 as “energy to heater” regulator 102).

The controller 66 determines, in one example, exactly how much energy is needed by the heater 62 to maintain a desired temperature set point to provide the exothermic oxygen reduction to occur. This amount of energy needed varies and is dependent on several factors including: Gas flow rate, including no flow conditions; Inlet gas temperature; Inlet gas oxygen concentration. A heater element temperature sensor 104 may be provided and may be coupled with the controller 66; and in one embodiment, the controller 66 can achieve temperature control via a single temperature sensor 104 that measures the temperature of the heater element.

An oxygen reducing catalyst 70 is contained within the pressure vessel/reactor 68 which is configured to support the catalyst material/media 70 and allow adequate contact between the oxygenated gas stream 22 and the catalyst material 70. A sulfur-removing material 110 may also be included within the reactor/vessel 68 upstream of the oxygen reducing catalyst 70, to help protect the effectiveness and life of the catalyst 70. An example of a pressure vessel/reactor 68 is illustrated in FIGS. 8-9.

In one example, in addition to monitoring and controlling the temperature of the heater element 100, the controller 66 may also monitor one or more temperature sensors (shown in FIG. 3 as reactor bed temperature sensors 112) that measure the temperature of the gas stream within the reactor/pressure vessel 68 as oxygen is reduced. If any of the temperature sensors measures that the gas stream temperature exceeds a set point (for instance due to too much oxygen in the gas stream), the controller 66 de-energizes/closes the inlet valve 60.

An oxygen analyzer 114 may be coupled with the controller 66 and with the main output 25 of the oxygen reduction system 20 to continuously sample the gas stream 26 downstream of the economizer 74 heat exchanger's cooler section. If the oxygen analyzer 114 detects an oxygen concentration above a set point that corresponds to a gas gathering pipeline's oxygen limitation/specification, the controller 66 opens the diverter valve 72 that is positioned downstream of the heat exchanger's 74 cooling section and upstream of the gas gathering line 30. When the controller 66 opens the diverter valve 72, the natural gas stream is sent to a different point other than the gas gathering line 30, i.e. a flare 32 or the tank battery 48 for re-cycling, etc.

The oxygen reduction system 20 may also include a power supply 120, which can be connected in one example to three-phase AC power 480 volts. The power supply 120 can be conditioned and regulated by the oxygen reduction system 20 to provide 24 volts DC, 480 volts AC, or other AC/DC voltages as desired.

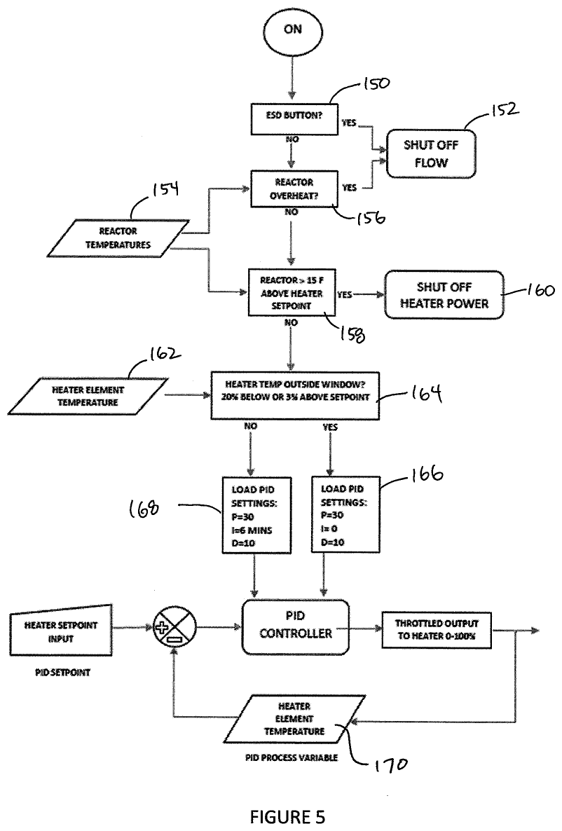

As discussed with reference to FIG. 5, for inlet valve operation and control, the controller/PLC 66 receives temperature signals, and sends out a flow-permissive signal which energizes the inlet valve 60 to be open. For controlling heater power, the controller/PLC 66 may run a PID loop to control heater power output using regulator 102. By controlling the power to the heater, controller 66 controls the heater temperature which is used maintain the temperature of the catalyst bed and processed gas above the activation temperature of the oxygen-reducing reaction.

The inlet valve 60 can act as a main process shutoff valve. Whenever there is a condition which requires flow to be stopped, the valve is closed by controller 66 and flow is stopped. These conditions are discussed herein, such as catalyst bed temperatures exceeding vessel maximum allowable temperature or the emergency stop/emergency shut-down (ESD) button being pushed. If an ESD button push has been detected, the controller 66 also removes energy/power applied thru regulator 102 to the heater elements 100.

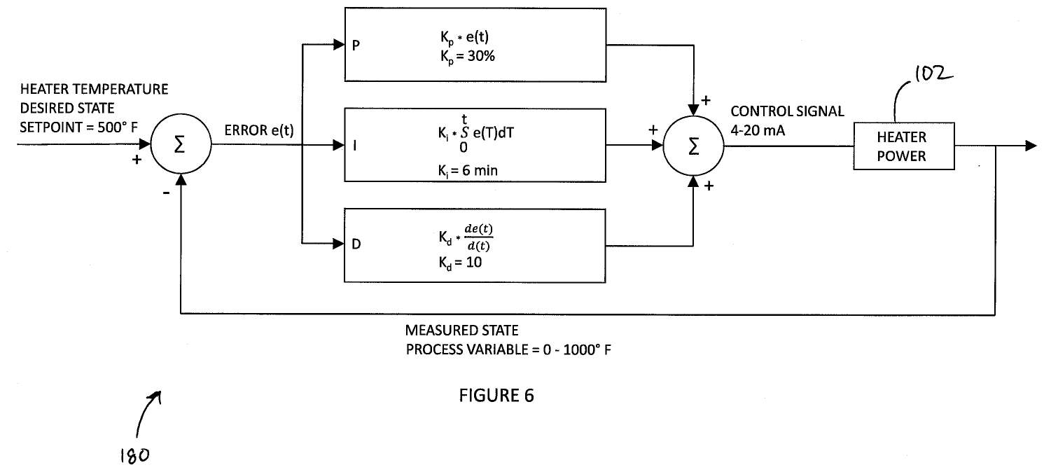

The heater 62 heats the main process gas stream, which passes through the catalyst bed, thereby raising the catalyst material's temperature high enough for the oxygen reaction to occur. In one example, the controller 66 monitors and controls the temperature of the heater elements 100 in order to control and maintain the temperature of the catalyst bed. In one example, a PID control loop and process (FIG. 6) implemented by the PLC/controller 66 takes the heater element temperature from sensor 104 as a process variable, and generates an output, which is then converted to a 4 mA to 20 mA output signal. This output signal runs to a control regulator 102 which limits the amount of energy, power (i.e., voltage) delivered to the heater resistive elements 100.

The heater control provided by the oxygen reduction system 20 of FIG. 3 eliminates the need for external communications or signals with components or devices upstream of the oxygen reduction system, regarding the presence or absence of gas flow. The heater control also decreases the amplitude of the fluctuations in temperature, which helps lengthen the life of heater 62, heat exchanger 74, and catalyst vessel 68.

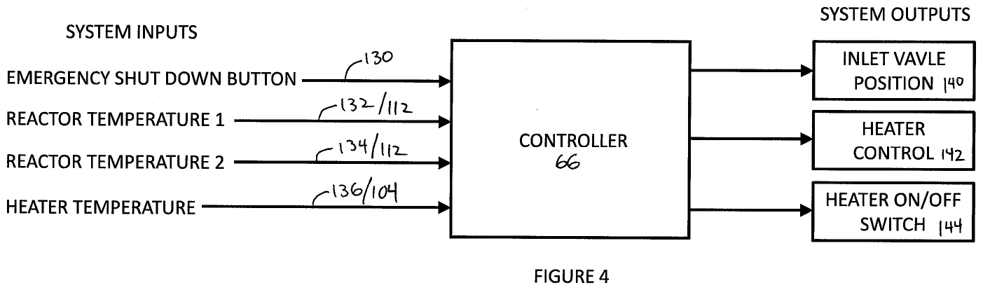

In FIG. 4, an example of a controller 66 or an oxygen reduction system 20 with a universal front end is illustrated, in accordance with one example of the present disclosure.

In one embodiment, the controller 66 incorporates four inputs as it uses programmed logic and close feedback control loop(s) to control three outputs. The controller 66 can be programmed to implement one or more of the processes, steps, operations, or features disclosed herein.

In one embodiment, inputs to the controller 66 may include but are not limited to an Emergency Shutdown Button/signal 130, twin reactor temperature sensors 132, 134 (112), and a heater temperature sensor 136/104. Multiple reactor temperature sensors 134, 134 may be included for redundancy, thereby enhancing safety. In one example, the controller 66 continuously monitors the presence of a signal from each temperature sensor—and if a signal from any temperature sensor is lost, the controller immediately shuts off all power to the heater 62 and de-energizes/closes the inlet valve 60.

In one embodiment, outputs of the controller 66 may include but are not limited to position signal 140 of an inlet valve (i.e., open or closed in one embodiment), heater control signal 142 (i.e. 0 to 100% power in one embodiment), and a heater on/off switch signal 144.

The oxygen reduction system 20 may be configured to remove oxygen by using an exothermic reaction, as described herein and also in commonly-owned U.S. Pat. No. 9,776,155, the disclosure of which is hereby incorporated by reference in its entirety.

FIG. 5 illustrates an example of a process for an oxygen reduction system with a universal front end, in accordance with one example of the present disclosure. The controller 66 can perform one or more of the operations illustrated in FIG. 5, along with performing one or more of the operations, steps, process steps, or functions described herein.

In one embodiment, once the system in initialized, the controller 66 first identifies whether an emergency shutdown situation is present (150). If the emergency shut down button is pressed, or if the condition is indicated by remote automation/telemetry, the controller shuts off flow (152) of incoming, oxygenated gas by de-energizing the inlet valve.

In one example, the controller 66 also continuously monitors reactor temperature via twin temperature sensors (154). Twin temperature sensors measure reactor temperature, as described above. If either temperature sensor senses that the reactor is above a maximum reactor temperature set point (156), the controller will similarly shut off flow (152) of incoming gas by de-energizing the inlet valve. Without incoming gas containing oxygen, the reactor begins to cool down.

The controller 66 also monitors reactor temperature sensors for another purpose related to heater control. If the controller determines (158) that reactor temperature is more than 15 F above the heater temperature setpoint, the controller fully shuts off power to the heater (160).

The controller 66 continuously monitors the temperature of the heater's elements (162). If the heater temperature is outside of a window (164) (i.e., a window bounded by 20% below heater temperature set point to 3% above heater temperature set point), the controller overwrites (166) the integral component of the Proportional, Integral, Derivative (PID) closed loop control equation with a value of zero (0).

If the heater temperature is within a window (i.e., a window bounded by 20% below heater temperature set point to 3% above heater temperature set point), the controller 66 does not interfere or modify the integral portion of the PID closed loop equation (168).

This results in the ability of the controller 66 to respond to varying flow rates with only one heater element temperature sensor and no external signals or inputs, including a scenario where the system experiences an instantaneous change from full flow to zero flow (i.e. an event where a compressor shuts down).

Power delivered to the heater 62 can be controlled by controller via a closed control feedback loop with a set point and a process variable, both associated with heater temperature, and an output that determines how much power the heater 62 needs to maintain that heater temperature set point.

Stated differently, in one embodiment of the present disclosure, the inlet valve 60 is a normally closed design. During normal operation, the valve 60 is energized to stay open. There are three inputs to the PLC/controller 66 which can potentially remove energy from the valve 60, to allow it to close.

One input that affects the inlet valve 60 is the ESD button. This can be a circuit which is closed during normal operation, and broken when the ESD button is pushed. The other two inputs are 2 reactor temperature sensors/thermocouples. The second temperature sensor is provided for redundancy/safety. If either of those thermocouples reads the Shutdown Temperature, the PLC 66 will de-energize the inlet valve 60, allowing it to close. If there is an issue with any of the thermocouple readings, like a broken thermocouple circuit, or minimum or maximum value reading, the same shutdown occurs.

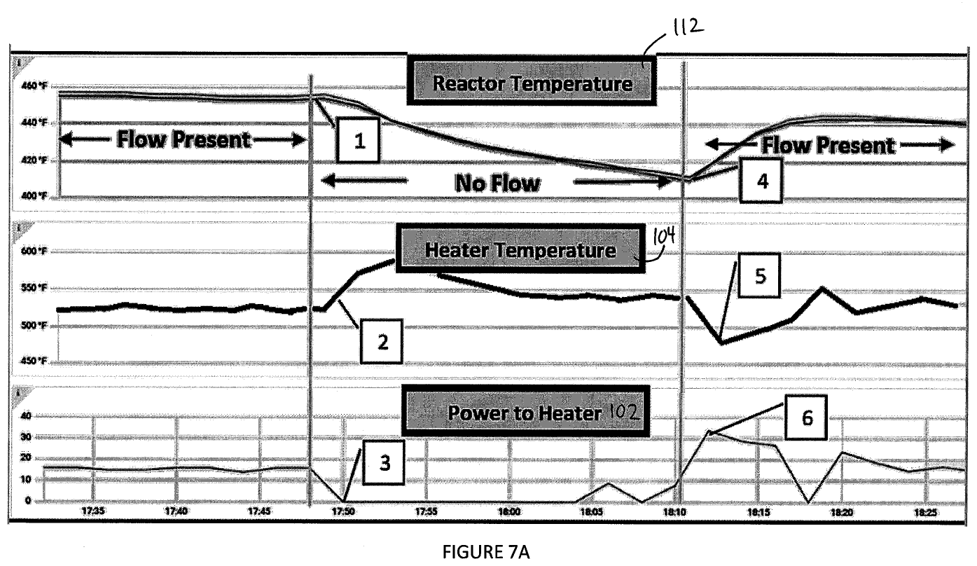

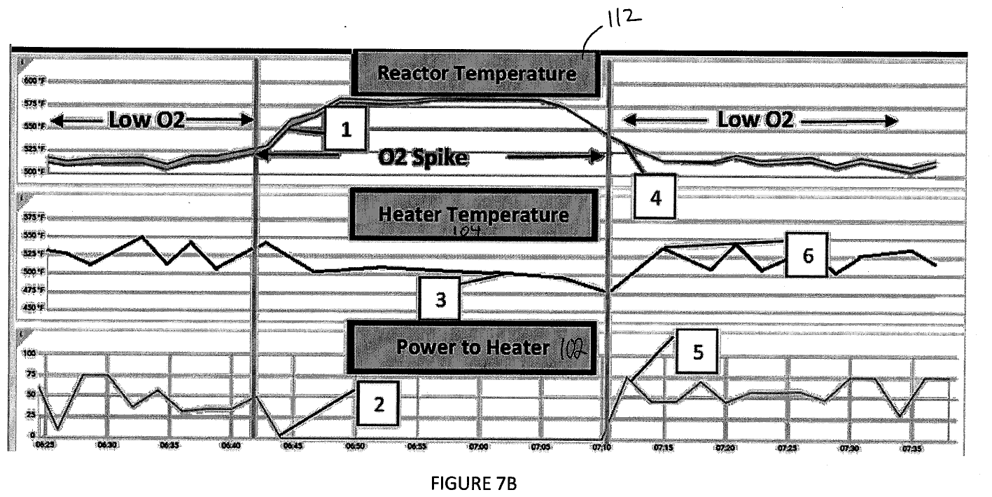

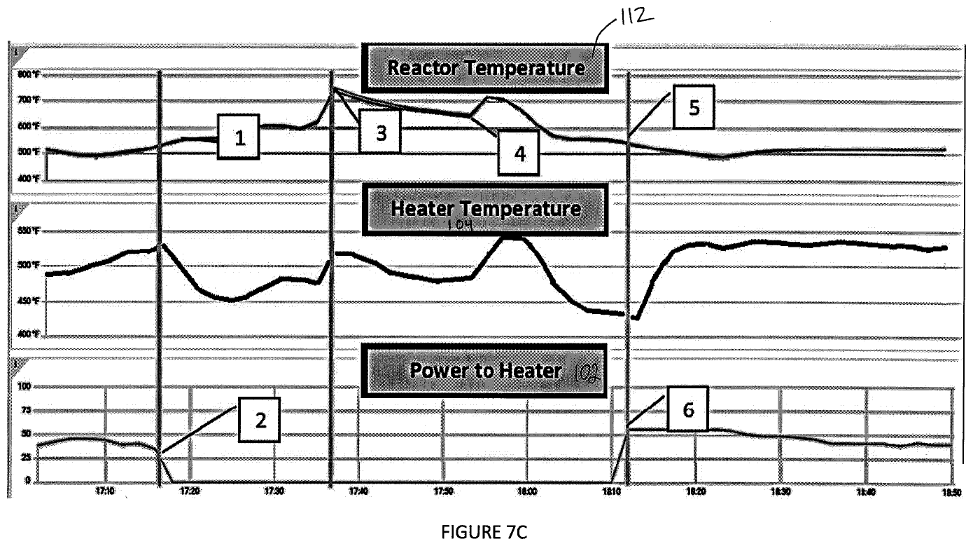

Concerning heat, the controller 66 operates to keep the catalyst bed above its activation temperature, regardless of flow conditions, and to keep the temperatures as steady as possible. Fluctuations in process flow, based on external factors, will cause fluctuations in temperature as shown in FIGS. 7A-C; however, embodiments of the present disclosure respond to such fluctuations to provide desired and controlled outcomes. In this manner, the oxygen reduction system 20 provides controlled heating of the processed gas which does not require any signal or communication to notify presence of flow, while keeping catalyst bed temperature and heating element temperature as steady as possible. The heated process gas then passes through the catalyst bed. This heated process gas is how the catalyst bed is heated and kept at the desired temperature.

In one embodiment, the controller 66 implements a PID loop process to control power output to the heater (see FIGS. 5-6). In one example, the heater control method described herein may use the heater element temperature (170 in FIG. 5, 104, 136), rather than the catalyst bed temperature 112, as the process variable in the PID control loop process. This results in less fluctuation in temperatures, both heater element and catalyst bed. In one embodiment, changes in flowrate may affect the process as follows:

More flow will result in the heater elements 100 being cooled via convection. When the PLC 66 reads a decrease in temperature at the element thermocouple, the PID control will respond with additional energy input to the heater. If flow decreases, or stops, the normal energy output to the heater will result in an increase in heater element temperature. When the PLC 66 reads an increase in temperature at the element thermocouple 104, the PID control will respond by decreasing, or cutting off the energy input to the heater. This corresponds to the reactor temperature 112 being held constant whenever there is flow, and heater temperature held constant at all times, in one example.

FIG. 6 illustrates an example of a proportional-integral-derivative (PID) control module 180 for an oxygen reduction system 20 with a universal front end, in accordance with one example of the present disclosure.

In one embodiment, the power throttle or regulator 102 (i.e. silicon-controlled rectifier, or SCR) that controls the energy (i.e., voltage or current) delivered to the heater 62/100 may be controlled by the output of a Proportional-Integral-Derivative Closed Loop Controller (PID) implemented as a process within the PLC 66. The input (i.e. process variable) into the PID loop is received by the PLC 66 from the heater temperature sensor 104 and the desired heater temperature, i.e. PID Set Point, may be manually set by the operator.

The temperature at the heater temperature sensor 104 that it maintains may be set by the operator where, in one embodiment, the temperature is set to 500 Fahrenheit. In one example, this may be accomplished by a method where the PLC receives a signal of the process variable from the temperature sensor 104 mounted to one of the heater elements. After receiving the temperature/Process Variable signal, the PID closed loop controller in the PLC calculates the desired heater power and sends the control Output as an electronic signal to the SCR 102, which in one example can translate that electric current signal to a corresponding power output and delivers that power to the heater 62/heater elements 100 accordingly.

Referring to FIGS. 3, 4, and 6, the output of the controller 66 proportionately controls the power delivered to the heater 62. In one example, where the heater is inserted into the reactor vessel 68 and is used to heat oxygenated natural gas to an elevated temperature required to catalytically reduce oxygen, the PID set point of heater temperature can be configured to be 500 F. The elements of the process control 180 described herein therefore include the control output signal as shown in FIG. 6 which controls the amount of power delivered to the heater by the SCR/regulator 102, the control process variable (i.e., heater temperature), and the control set point (i.e., heater temperature set point, as shown in FIG. 6). When the heater element temperature drops below the control set point (i.e. heater temperature set point), the heater temperature sensor detects this change in the process variable as the PLC's PID closed feedback control loop logic sees a growing error between the control set point and the process variable. Accordingly, through a proportional integral and derivative controller (PID closed loop controller), the controller 66 will direct the SCR/regulator 102 to direct more power to the heater 62/heater element 100 so that the heater can heat the oxygenated natural gas an appropriate amount to provide sufficient gas temperature and thereby drive the oxygen reduction process via catalytic reaction, thereby reducing oxygen to a reduced concentration lower than the gas gathering pipeline's oxygen concentration limits.

Referring FIG. 6 and the proportional integral and derivative closed-loop feedback control system 180, which can be implemented using the controller 66, three components of the system include the set point (e.g., the parameter that is being controlled), the process variable (e.g., the current state at which that parameter exists), and the control signal that actually would change or influence the process variable. In this case, the set point is the temperature that exists at the heater element(s), where it is desirable in one example to have this consistently be 500 degrees Fahrenheit. The process variable is the actual temperature at the heater elements at a given moment as measured by the heater temperature sensor 104, which could range from 0 to 1000 F in one embodiment.

The proportional part of the controller measures purely the deviation or difference between the set point and the measured process variable. The further the measured variable is from the set point, the more that the proportional component tries to push the measured variable back to the set point.

The integral part of the controller looks back over a given amount of time and it determines how far off has the process variable has been from the set point over this time period. In one embodiment, a 6-minute “reset” or time window can be used to determine how far off the process variable is from the set point, and the integral portion bumps the output in a way that moves the process variable closer to the set point. For instance, by way of an example to illustrate how the integral component of a PID closed feedback control loop functions, in an automotive cruise control application, the integral term effectively balances the aerodynamic drag forces experienced by a vehicle as it travels at a given speed.

The derivative component of the controller detects the rate of change which helps predict where the process variable is heading. In one example, the derivative term is assigned a value of zero so only the proportional and integral components are used. In another embodiment, the derivative term is assigned a non-zero scalar (i.e. a “rate” term of 10) to allow the control output to quickly respond to changing operating conditions. If the rate/derivative term scalar is too large, the control output can become unstable.

In one example of operation of FIG. 6, assume that the flow rate instantly increases (i.e. a compressor 36 turns on and starts running from a resting state) and a temperature below the control set point (i.e., 500 F in one embodiment) develops at the heater elements (i.e., 450 F in one embodiment). The temperature sensor 104 senses the process variable to be a temperature lower than the control set point, and the proportional component determines that there is a significant error term or variance between the set point and the measured state/process variable. The proportional component then tries to adjust the process variable by increasing the control signal, which, in one embodiment, is directly and proportionally controlling the amount of power delivered to the heater 62 which thereby increases the heater temperature (i.e. process variable) closer towards the set point. The proportional term component will get the control process variable (i.e., heater element temperature) very close so the control set point (i.e., 500 F) but it will always be within some infinitesimal difference. The integral component or the “reset” term value can be used to bump the process variable to the set point.

In one example of operation described both by FIG. 5 and FIG. 6, assume that the flow rate instantly decreases (i.e., a compressor 36 turns off from a running state) removing the cooling effect that incoming gas has on the heater elements and a temperature above the setpoint (i.e., 500 F in one embodiment) develops at the heater elements (i.e., 550 F in one embodiment). The temperature sensor 104 senses the process variable to be a temperature higher than 3% above the control setpoint. The proportional component determines that there is a significant error term or variance between the set point and the measured state/process variable, however, this error term is negative according to the equation referenced in FIG. 6, causing the proportional term to remain at zero as direct-acting closed feedback control loop outputs cannot be a negative value.

However, in a typical direct-acting closed feedback control loop, the integral component could continue to drive the output to be positive even though the process variable is higher than the setpoint if, in the immediately preceding period of time (this time period is bounded by the Integral term's scalar term often referred to as “reset”) the process variable (i.e., heater element temperature) was, on average, lower than the control setpoint (i.e., 500 F in one example).

In one example, to reduce or minimize overshoot of the process variable above the control setpoint, the integral term is overwritten to have a value of zero (0) whenever the process variable (i.e., heater element temperature) is more than 3% above the control setpoint (i.e., 500 F in one embodiment).

In one embodiment, the integral term of the closed feedback control loop shown in FIG. 6 is similarly overwritten with a value of zero whenever the process variable is more than 20% below the control setpoint. In one embodiment where the closed feedback control loop is configured to be direct acting (also referred to as forward acting), the proportional term will drive a positive control output that will bring the heater temperature up to within 20% of the control setpoint, at which point the integral term will be reinstated and no longer overridden with a value of zero. Typically this condition is only experienced during initial startup when the entire system is initialized at ambient temperature.

FIG. 7A illustrates an example of a scenario for an oxygen reduction system 20 with a universal front end, showing a response of the oxygen reduction system 20 when gas or vapor flow into the oxygen reduction system stops or is interrupted, in accordance with one example of the present disclosure. At event 1, flow through system 20 stops; reactor temperature 112 starts to decrease. At event 2, heater temperature 104 increases due to input power, and lack of convectional cooling. At event 3, controller 66 sees increase in heater temperature 104, enough to remove all power. At event 4, flow is re-introduced; reactor temperature 112 starts to increase. At event 5, heater temperature 104 decreases due to low input power, and convectional cooling. At event 6, controller 66 reacts by increasing power output 102 to heater 62/100.

FIG. 7B illustrates an example of a scenario for an oxygen reduction system 20 with a universal front end, showing a response of the oxygen reduction system 20 when the gas or vapor flow into the oxygen reduction system has a sudden increase or spike in oxygen-content and the system 20 continues to operate, in accordance with one example of the present disclosure. At event 1, reactor temperatures 112 spike greater than 15 F above heater temperature setpoint, due to a large spike in oxygen coming in. At event 2, the controller 66 reacts by removing power output 102 to heater 62/100. At event 3, heater temperature 104 decreases. At event 4, reactor temperature 112 falls back below the cutoff temperature. At event 5, the controller 66 reacts by introducing power 102 back to heater 62/100. At event 6, heater temperature 104 increases.

FIG. 7C illustrates an example of a scenario for an oxygen reduction system 20 with a universal front end, showing another response of the oxygen reduction system 20 when gas or vapor flow into the oxygen reduction system 20 has a significant increase or spike in oxygen-content and the system 20 shuts down input gas flow, in accordance with one example of the present disclosure. At event 1, reactor temperatures 112 spike greater than 15 F above heater temperature setpoint, due to a large spike in oxygen coming in. At event 2, controller 66 reacts by removing power output 102 to heater 62/100. At event 3, reactor temperature continues to increase due to exothermal oxygen reaction, to the point of shutdown temperature. Inlet Valve 60 is closed by controller 66 to shuts off all flow into reactor 68. At event 4, reactor temperature 112 cools to the point where inlet valve 60 is opened up again by controller 66 to re-introduce flow. Smaller spikes in temperature may be seen, from existing oxygen in pipes of the system 20, but not enough to shut flow off. At event 5, reactor temperature 112 falls back below the cutoff temperature. At event 6, controller 66 reacts by introducing power 102 back to heater 62/100. The heater temperature 104 increases.

FIGS. 8-9 illustrate an example of a vessel 68 with an internal heater 62 that may be used with an oxygen reduction system 20 with a universal front end, in accordance with one example of the present disclosure.

In FIGS. 8-9, a path of the gas flow through a reactor vessel 68 is shown. The gas enters the reactor vessel through the inlet process connection 200. The gas then flows upward through an inner pipe 202 and across heater elements 100. The gas then billows over top of the inner pipe 202 and flows downward through the catalyst bed 70. Finally, the gas leaves the reactor vessel through the outlet process connection 204.

The reactor vessel 68 is constructed in a vertical orientation. The reactor vessel is orientated in a vertical fashion so it will force the gas to flow across the entire catalyst bed 70.

The vessel 68 may include two components: the body 206 and the cap 208. The vessel body and cap are fastened together via mating flanges. The vessel body contains an inner pipe 202 that is concentric within the shell 210 of the vessel and is supported by welded supports. The inner pipe 202 houses the heater 62/100 but does not contain any of the catalyst bed 70. The catalyst bed 70 is only located within the annulus of the vessel body 206 and is supported by the vessel internal structures.

In one example, the vessel internal structures may include a bottom support ring, a large hole perforated plate, a small hole perforated sheet, a top support ring and a mesh screen. The top and bottom support rings may be welded to the inside of the vessel body. The large hole perforated plate and the small hole perforated sheet may be sandwiched between the top and bottom support rings. The mesh screen can rest on top of the small hole perforated sheet within the inner diameter of the top support ring.

The vessel body may include a man-way that allows access to the vessel for maintenance. The man-way contains a removable plug that prevents catalyst from leaking out when initially opened.

The vessel cap 208 is removable from the vessel body 206. The vessel cap 208 is removable because it allows for installation of catalyst 70 within the annulus of the vessel body. The top of the vessel cap can provide a connection point for the heater.

In one example, the catalyst bed 70 is a relatively large amount of mass, which increases the temperature at a rate of 15 degrees per minute during startup, and decreases at an average rate of 1-3 degrees per minute when flow is lost. The heater element 100 has less mass, and can increase at a rate of 20-30 degrees per minute during flow, and up to 180 degrees per minute during no flow.

Due to the design of the vessel 68, during times where flow is non-existent or very low, the heater 62/100 can be kept at an elevated temperature even when the catalyst bed 70 does not have the heated process gas flowing through it to keep it at the elevated temperature. By designing the catalyst vessel 68 such that the heater 100 is in the middle of the bed, this keeps the catalyst temperature as high as possible during times of no flow.

FIG. 8 shows an isometric view of one embodiment of the reactor vessel 68 of a stand-alone oxygen reduction system 20.

In one embodiment, the inlet nozzle 200 is positioned above the outlet nozzle 204. The upstream side of inlet nozzle has a flange that can connect to the outlet of the cold section of an economizing heat exchanger 74. The inlet flange penetrates the shell of the reactor vessel and mates to a vertically oriented inner pipe 202. Natural gas containing oxygen moves through the inlet nozzle before it enters the vertically oriented inner pipe 202.

The vertically oriented inner pipe 202 both directs the flow of oxygenated natural gas upwards. It also serves to contain the heater 62/100. As the natural gas travels upwards through the inner pipe 202, it contacts the heater element 100 that heat the natural gas to a desired elevated temperature.

Once the gas has traveled to the top of the inner pipe 202, it is fully heated. It then changes direction to travel downwards between the outside of the inner pipe 202 and the inner side of the vessel shell. This space, referred to as the annulus, contains oxygen-reducing catalyst 70.

A series of perforated metal sheets and screens laid upon one another support the catalyst 70 and keeps in inside the reactor vessel, preventing it from flowing through the outlet nozzle. In one embodiment, three screens are used. The bottom layer is the thickest and has the largest perforations (i.e. holes). In one embodiment this layer is ½″ thick with ¼″ diameter perforations, and provides structural support for the entire catalyst bed and is welded to the inner diameter of the vessel shell. However, the perforations are far larger than the diameter of the catalyst media. Without additional layers added above with smaller perforations, catalyst 70 would fall through and exit the vessel through the discharge nozzle.

In one embodiment, the middle layer is a perforated sheet of metal. Both the thickness and perforation size are smaller than the bottom layer but larger than the top layer. In one example it is ⅛″ thick with ⅛″ diameter perforations, and provides support for the top layer. In one embodiment, it is welded to the inner diameter of the reactor vessel and the bottom layer.

In one embodiment, the top layer is a mesh screen made of stainless steel. The mesh size is smaller than the tiniest catalyst particles found in the catalyst bed, preventing any catalyst media from exiting the reactor vessel. However, it is also the thinnest of the layers and would be unable to support the entire catalyst bed on its own, therefore further support is provided from the layers below. In one embodiment, it is cut to size and rests above the middle layer, and is not welded or affixed permanently to the reactor vessel itself.

In one embodiment, the discharge nozzle 204 connects to the reactor vessel at the very bottom of the reactor. A 90 degree elbow interfaces between the reactor vessel and the strait section of the discharge nozzle. A flange on the downstream side of the discharge nozzle 204 can connect to the hot section of an economizing heat exchanger in one embodiment.

By placing the heater 62/100 within the vessel 68, as opposed to in a separate vessel or pipe located upstream of the reactor vessel, heat from the heater isn't lost. Instead, it is directed into the catalyst 70.

In one embodiment, mating flanges are incorporated near the top of the reactor vessel 68. Once the studs and nuts that bolt the mating flanges together are loosened and removed, the top section (i.e. the top head, top flange, and heater) can be lifted, thereby allowing access to the inside of the vessel for catalyst fill, replacement, cleanout, or other maintenance.

In one embodiment, a maintenance flange 212 is incorporated near the bottom of the vessel but above the layers of perforated metal and screen. Perpendicularly mounted to the vertically oriented shell of the reactor vessel, this flange 212 is capped with a blind flange during operation. However, once the studs and nuts that bolt the mating flanges together are loosened and removed, the top section (i.e. the top head, top flange, and heater) can be lifted, thereby allowing access to the inside of the vessel for catalyst fill, replacement, cleanout, or other maintenance.

In one embodiment, the vessel 68 can be fitted with a skirt 214 that mates to the bottom of the vessel, to support the vessel and allow it to stand or be mounted on a skid, a reinforced concrete pad, or another horizontal surface.

FIG. 9 depicts a sectional view of one embodiment of the oxygen reducing reactor vessel 68 and the catalysts 70 it contains. In one embodiment, two types of catalyst are used.

The top layer is also the upstream layer that the gas contacts first. It can be a sulfur scavenger material 110 that removes any H2S or other forms of sulfur (i.e. COS) that are harmful to oxygen reducing catalyst. Sulfur scavenger composition 110 can include but is not limited to iron oxide (Fe2O3) or zinc oxide (ZnO).

A mesh screen can be used to separate the catalysts types.

The bottom layer is also the downstream layer that the gas contacts after the top layer of catalyst. The bottom layer can be an oxygen reducing catalyst 70 that reduces the concentration of oxygen in a natural gas stream.

Embodiments of an oxygen reduction system 20 may utilize catalytic materials such as sulfur scavenging catalysts 110 such as zinc oxide, and oxygen removing/reducing catalysts 70 such as palladium, within the vessel/reactor. In one example, zinc oxide material (i.e., a bed of zinc oxide) or other material which acts as a sulfur scavenger 110 is positioned to first receive heated oxygenated gas; and in a second location within the reactor/vessel, a palladium catalyst or other material 70 which operates to reduce the oxygen (02) concentration by lowering the activation energy required to facilitate combustion between oxygen and the heated gas stream, effectively eliminating the limiting reagent as the heated gas stream passes through the oxygen reducing catalyst at or above a given temperature and pressure. In one example, oxygen is the limiting reagent and the threshold pressure and temperature vary with the composition of the gas stream. In one example, the pressure vessel reactor 68 is positioned vertically or substantially vertically, so that the natural gas stream flows downwardly through the reactor vessel which essentially packs in the catalytic pebbles and thus reduces the possibility of any channeling of the gas stream. This also ensures contact between the processed natural gas stream and the materials contained in the reactor, respectively resulting in the most efficient reduction of oxygen content. In one example, the bed of zinc oxide acts as a sulfur scavenger 110 and protects the palladium catalysts or oxygen reducing catalysts 70 from the poisoning effects of sulfur. In place of zinc oxide, other materials or solutions may be used to remove sulfur from the gas stream, including amine solutions of monoethanolamine (MEA) and diethanolamine (DEA). It is also possible to use solid desiccants like iron sponges or polymeric membranes.

As the processed heated gas stream passes through the zinc oxide scavenger bed 110, sulfur atoms are exchanged with the oxygen atoms in the zinc oxide and removed from the gas stream, as shown in the example reaction:

ZnO+H2S→ZnS+H2O

Acting as a sacrificial bed, the zinc oxide bed 110 may be replaced periodically.

In place of the palladium catalyst in the reactor, other materials (i.e., noble metals) may be used, including platinum or palladium/platinum blends. In another example, materials 70 comprising metals such as nickel, cobalt, copper, iron, silver, and gold can be used to cause the oxygen present in the gas stream to react with the metals and reduce the oxygen content in the gas stream.

The oxygen-reducing catalyst material 70 is provided to facilitate the combustion of the oxygen with hydrocarbons in the processed stream of natural gas while in the reactor. The oxygen in this case is the limiting reagent and is thus burned up once the light-off temperature is achieved within the reactor when the gas is at sufficient temperature and pressure, effectively removing or reducing oxygen concentrations present in the gas stream. The catalytic reaction inside of the reactor eliminating the oxygen is an exothermic reaction.

Having passed through the reactor at a desired pressure and temperature, the natural gas stream has substantially less sulfur and oxygen content than it had it prior to entry into the oxygen reduction system 20, and as described herein, in one embodiment the system 20 automatically adapts its operations based on internal conditions detected without the need for signal connections to other components such as VRUs, compressors, etc.

While the methods disclosed herein have been described and shown with reference to particular operations performed in a particular order, it will be understood that these operations may be combined, sub-divided, or re-ordered to form equivalent methods without departing from the teachings of the present disclosure. Accordingly, unless specifically indicated herein, the order and grouping of the operations is not a limitation of the present disclosure.

It should be appreciated that in the foregoing description of exemplary embodiments of the disclosure, various features of the disclosure are sometimes grouped together in a single embodiment, figure, or description thereof for the purpose of streamlining the disclosure and aiding in the understanding of one or more of the various aspects. This method of disclosure, however, is not to be interpreted as reflecting an intention that an embodiment requires more features than are expressly recited in each claim. Rather, inventive aspects lie in less than all features of a single foregoing disclosed embodiment, and each embodiment described herein may contain more than one inventive feature.

It will be understood by those skilled in the art that various changes in the form and details may be made from the embodiments shown and described without departing from the spirit and scope of the disclosure.

1. An oxygen reduction system for reducing an amount of oxygen from a stream of natural gas, comprising:
a controllable inlet valve receiving the stream of natural gas, the inlet valve having an output;
a controllable heating element receiving the output of the inlet valve and heating the stream of natural gas, the heating element having an output providing heated gas; and
a vessel containing an oxygen reducing catalyst, the vessel receiving the heated gas and reducing oxygen contained within the heated gas, the vessel having an output providing oxygen reduced gas.

2. The system of claim 1, further comprising:
at least one temperature sensor detecting the temperature of the heating element;
at least one temperature sensor detecting the temperature of the catalyst vessel; and
a controller receiving said detected temperature of the heating element and the temperature of the catalyst vessel, the controller having an output coupled with the inlet valve to control the inlet valve, the controller also having another output coupled with the heater to control the heater.

3. The system of claim 2, wherein the controller regulates the flow of gas into the inlet valve based on the temperature of the heating element.

4. The system of claim 2, further comprising:
a controllable outlet valve receiving the oxygen reduced gas, the outlet valve having a control line coupled with the controller, the controller selectively diverting the oxygen reduced gas through the outlet valve to a sales line or to a flare.

5. The system of claim 1, further comprising:
a heat exchanger having a first input receiving the stream of natural gas from the output of the inlet valve and a second input receiving the output from the vessel, the heat exchanger providing a first output to an input of the heater and a second output to a gas gathering line.

6. The system of claim 1, wherein the stream of natural gas is provided from a compressor.

7. The system of claim 1, wherein the stream of natural gas is provided from vapor recovery unit (VRU).

8. The system of claim 1, wherein the heating element is a resister.

9. The system of claim 1, wherein the vessel is vertically orientated.

10. The system of claim 1, wherein the vessel contains a sulfur removing material.

11. The system of claim 2, wherein the controller closes the inlet valve if the temperature of the heating element exceeds a setpoint.

12. The system of claim 2, wherein the controller closes the inlet valve if the controller does not detect the temperature of the heating element.

13. The system of claim 1, wherein the heating element is positioned within the vessel.

14. The system of claim 2, further comprising an oxygen sensor detecting an amount of oxygen content in the oxygen reduced gas, wherein the controller is coupled with said oxygen sensor.

15. An oxygen reduction system for reducing an amount of oxygen from a stream of natural gas, comprising:
a controllable inlet valve receiving the stream of natural gas, the inlet valve having an output;
a controllable heating element receiving the output of the inlet valve and heating the stream of natural gas, the heating element having an output providing heated gas; and
a vessel containing an oxygen reducing catalyst, the vessel receiving the heated gas and reducing oxygen contained within the heated gas, the vessel having an output providing oxygen reduced gas;
wherein the heating element is positioned within the vessel.

16. The system of claim 15, wherein the stream of natural gas is provided from a compressor.

17. The system of claim 15, wherein the stream of natural gas is provided from vapor recovery unit (VRU).

18. The system of claim 1, wherein the heating element is a resister.

19. An oxygen reduction system for reducing an amount of oxygen from a stream of natural gas, comprising:
a controllable inlet valve receiving the stream of natural gas, the inlet valve having an output;
a controllable heating element receiving the output of the inlet valve and heating the stream of natural gas, the heating element having an output providing heated gas;
a vessel containing an oxygen reducing catalyst, the vessel receiving the heated gas and reducing oxygen contained within the heated gas, the vessel having an output providing oxygen reduced gas;
at least one temperature sensor detecting the temperature of the heating element;
at least one temperature sensor detecting the temperature of the catalyst vessel; and
a controller receiving said detected the temperature of the heating element and the temperature of the catalyst vessel, the controller having an output coupled with the inlet valve to control the inlet valve, the controller also having another output coupled with the heater to control the heater.

20. The system of claim 19, wherein the controller regulates the flow of gas into the inlet valve based on the temperature of the heating element.
